(19) United States
(12) Patent Application Publication
(10) Pub. No.: US 2022/0156528 A1
(43) Pub. Date: May 19, 2022

(54) DISTANCE-BASED BOUNDARY AWARE SEMANTIC SEGMENTATION

(71) Applicant: QUALCOMM Incorporated, San Diego, CA (US)

(72) Inventors: Shubhankar Mangesh BORSE, San Diego, CA (US); Fatih Murat PORIKLI, San Diego, CA (US); Yizhe ZHANG, San Diego, CA (US); Ying WANG, San Diego, CA (US)

(21) Appl. No.: 17/528,141

(22) Filed: Nov. 16, 2021

Related U.S. Application Data
(60) Provisional application No. 63/114,491, filed on Nov. 16, 2020.

(51) Int. Cl. G06K 9/62; G06N 3/08

(52) U.S. Cl. CPC G06K 9/6269; G06N 3/08; G06K 9/6261; G06K 9/628

(57) ABSTRACT

A method applies a distance-based loss function to a boundary recognition model. The method classifies boundaries of an input with the boundary recognition model. The method also performs semantic segmentation based on the classifying of the boundaries, and outputting a segmentation map showing different classes of objects from the input, based on the semantic segmentation. The method may train an inverse transforming artificial neural network to predict a perspective transformation of an image so that the trained artificial neural network represents the distance-based loss function. The method may freeze weights of the inverse transforming artificial neural network, after training, to obtain the distance-based loss function. Training of the inverse transforming artificial neural network may include generating shifted, translated, and scaled versions of the image such that a ground truth comprises values corresponding to the amounts of shifting, translating, and scaling.

### CROSS-REFERENCE TO RELATED APPLICATION

The present application claims the benefit of U.S. Provisional Patent Application No. 63/114,491, filed on Nov. 16, 2020, and titled “BOUNDARY PREDICTION WITH DISTANCE-BASED LOSS FUNCTION,” the disclosure of which is expressly incorporated by reference in its entirety.

### FIELD OF THE DISCLOSURE

Aspects of the present disclosure generally relate to a distance-based loss function for boundary aware segmentation.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks, such as boundary recognition. It would be desirable to improve implementation of such tasks.

### SUMMARY

According to aspects of the present disclosure, a method applies a distance-based loss function to a boundary recognition model. The method also classifies boundaries of an input with the boundary recognition model. The method further performs semantic segmentation based on the classifying of the boundaries, and outputs a segmentation map showing different classes of objects from the input, based on the semantic segmentation.

In other aspects of the present disclosure, an apparatus for wireless communications performed by a wireless device includes a processor and memory coupled with the processor. Instructions stored in the memory are operable, when executed by the processor, to cause the apparatus to apply a distance-based loss function to a boundary recognition model. The apparatus may also classify boundaries of an input with the boundary recognition model. The apparatus may further perform semantic segmentation based on the classifying of the boundaries and may output a segmentation map showing different classes of objects from the input, based on the semantic segmentation.

In still other aspects of the present disclosure, a device includes means for applying a distance-based loss function to a boundary recognition model. The device also includes means for classifying boundaries of an input with the boundary recognition model. The device further includes means for performing semantic segmentation based on the classifying of the boundaries, and means for outputting a segmentation map showing different classes of objects from the input, based on the semantic segmentation.

In further aspects of the present disclosure, a non-transitory computer-readable medium with program code recorded thereon is disclosed. The program code is executed by a device and includes program code to apply a distance-based loss function to a boundary recognition model. The device also includes program code to classify boundaries of an input with the boundary recognition model. The device further includes program code to perform semantic segmentation based on the classifying of the boundaries, and program code to output a segmentation map showing different classes of objects from the input, based on the semantic segmentation.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram showing an example of a model for boundary detection and semantic segmentation.

FIG. 5 is a diagram showing cross-entropy between images for two different scenarios.

FIG. 6 is block diagram showing neural network training for distance-based features, in accordance with aspects of the present disclosure.

FIGS. 7A and 7B are diagrams showing distance-based measures of differences between pairs of input images, in accordance with aspects of the present disclosure.

FIG. 8 is a block diagram showing a boundary detection and semantic segmentation model, in accordance with aspects of the present disclosure.

FIG. 9 is a flow diagram illustrating a method for operating a neural network, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Machine learning may incorporate models, such as artificial neural networks. The neural networks may predict an object boundary in an image. By detecting an object boundary, object recognition and semantic segmentation algorithms may be improved. Segmentation may include separating a background from a foreground of an image, for example. More specifically, semantic segmentation labels specific regions of an image according to what is seen to locate a boundary between object in the image. The model labels each pixel of an image with a class corresponding to what is being represented. In a simple example, the model may label each pixel as either a background pixel or a foreground pixel. An example use case includes indoor segmentation for augmented reality or virtual reality (AR/VR) algorithms for a camera. Another example use case is outdoor segmentation for autonomous driving. Semantic segmentation classifies objects in the environment, for example, as cars, bicyclists, pedestrians, lanes, and background information. Other use cases include medical image diagnostics and camera quality improvement.

Conventionally, boundary recognition processes are trained with pixel intensity-based loss functions. These loss functions calculate the pixel-wise mean-square error or cross-entropy error between a neural network's boundary prediction and a ground truth label. Pixel-wise loss functions do not have an internal measure of distance. For example, if the boundary prediction shifts by a single pixel, the boundary prediction will have the same loss as when the prediction shifts by twenty pixels.

Aspects of the present disclosure aim to bring a distance measure to the loss function to improve boundary prediction. According to aspects of the present disclosure, to create a distance-based loss function, a small neural network is trained to output values of an affine transformation matrix between input and target images. This neural network may be trained by synthetically generating shifted, translated, and scaled versions of images. The ground truth values are the values of shifting, translating, and scaling. Once the neural network is trained, the neural network weights are frozen and the norm of its output is used as a loss function to replace or augment cross-entropy loss during training of the boundary recognition model. As a result of using the distance-based loss function, boundary detection improves. Moreover, performance of semantic segmentation improves. That is, segmentation and boundary detection may use a shared network backbone that is trained on both semantic segmentation and boundary recognition.

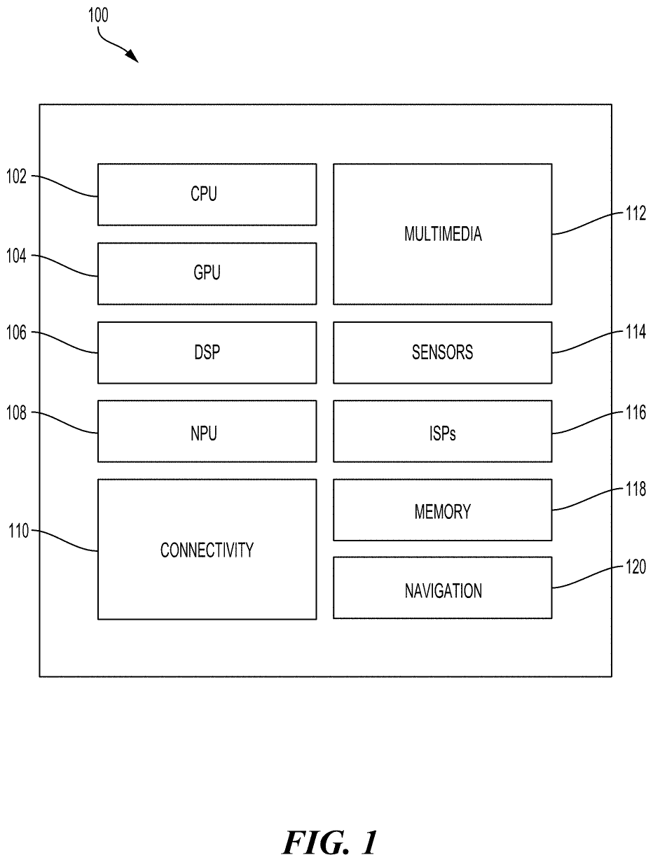

FIG. 1 illustrates an example implementation of a system-on-a-chip (SOC) 100, which may include a central processing unit (CPU) 102 or a multi-core CPU configured for boundary prediction with a distance based-loss function. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to apply a distance-based loss function to a boundary recognition model. The general-purpose processor 102 may also include code to classify boundaries of an input with the boundary recognition model. The general-purpose processor 102 may further include code to perform semantic segmentation based on the classifying of the boundaries, and code to output a segmentation map showing different classes of objects from the input, based on the semantic segmentation.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

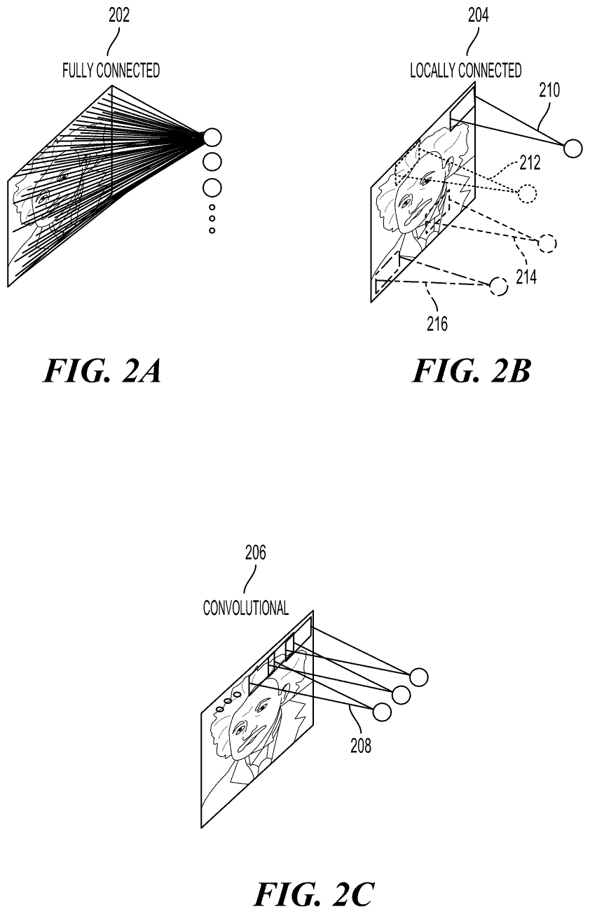

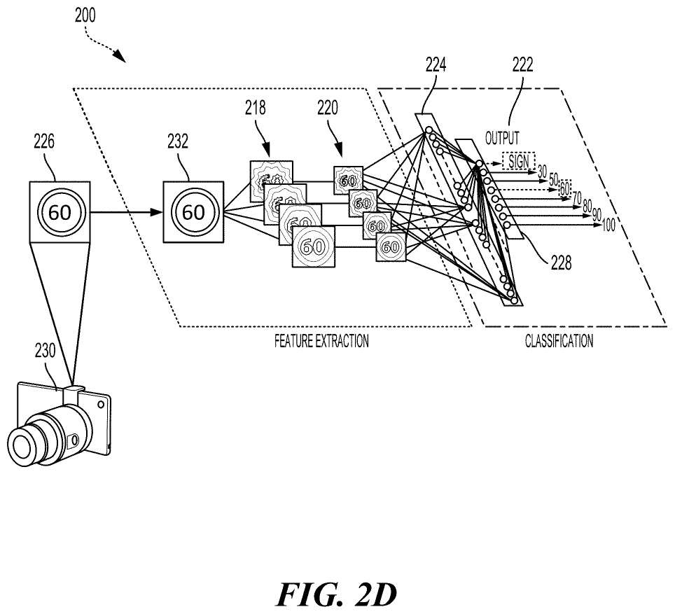

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

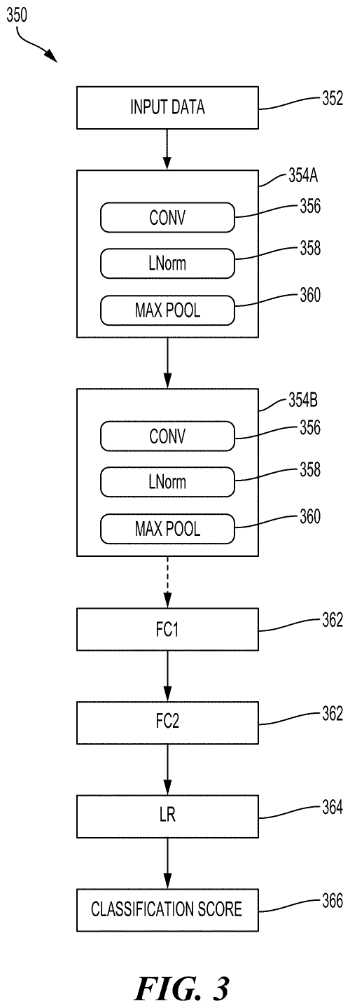

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

One type of feature that may be detected by the deep convolutional network 350 is an object boundary in an image. By detecting an object boundary, object recognition and semantic segmentation algorithms may be improved. Segmentation may include separating a background from a foreground of an image, for example. An example use case includes indoor segmentation for augmented reality or virtual reality (AR/VR) algorithms for a camera. Another example use case is outdoor segmentation for autonomous driving. Yet another use case is camera quality improvement.

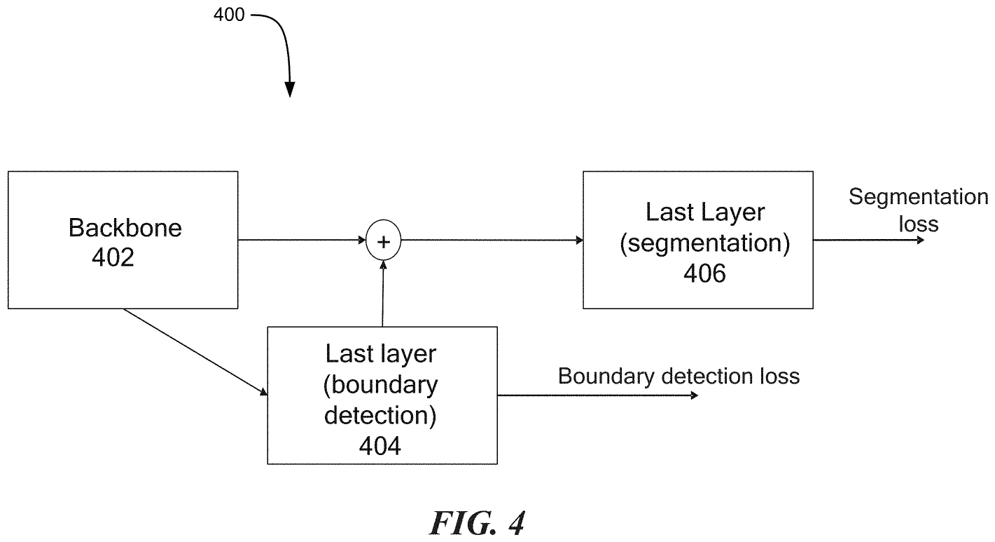

FIG. 4 is a block diagram showing an example of a model 400 for boundary detection and semantic segmentation. The model 400 may be a neural network including multiple portions, such as a backbone 402, a last layer for boundary detection 404, and a last layer for segmentation 406. To perform boundary detection and semantic segmentation, the backbone 402 of the neural network receives and processes an input image or sequence of input images. The backbone 402 generates an output based on the processing. The last layer of the neural network for boundary detection 404 receives the output from the backbone 402. The last layer for boundary detection 404 predicts boundaries of the input image based on its processing of the output received from the backbone 402. The predicted boundaries are combined with the output from the backbone 402 and then input to the last layer for semantic segmentation 406, where a segmentation loss is generated for training of the model 400. The last layer for boundary detection 404 also generates a boundary detection loss, for additional training of the model 400.

Conventionally, boundary recognition processes are trained with pixel intensity-based loss functions. These loss functions calculate the pixel-wise mean-square error or cross-entropy error between a neural network's boundary prediction and a ground truth label. Pixel-wise loss functions do not have an internal measure of distance. For example, if the boundary prediction shifts by a single pixel, the boundary prediction will have the same loss as when the prediction shifts by twenty pixels.

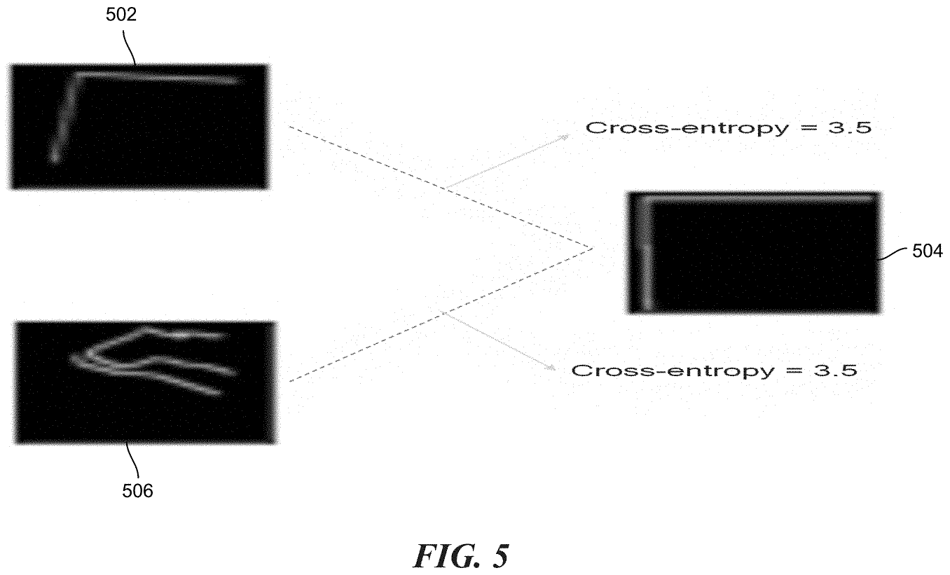

FIG. 5 is a diagram showing cross-entropy between images for two different scenarios. A first image 502 has a cross-entropy of 3.5 with a second image 504. It can be seen that the first image 502 looks somewhat similar to the second image 504. A third image 506 also has a cross-entropy of 3.5 with the second image 504. The third image 506, however, looks significantly different from the second image 504. It can be seen that a cross-entropy loss function would not necessarily correlate well with a difference between images. Aspects of the present disclosure aim to bring a distance measure to the loss function to improve boundary prediction.

According to aspects of the present disclosure, to create a distance-based loss function, a small neural network is trained to output values of an affine or perspective transformation matrix between input and target images. This neural network may be trained by synthetically generating shifted, translated, and scaled versions of images. The ground truth values are the values of shifting, translating, and scaling.

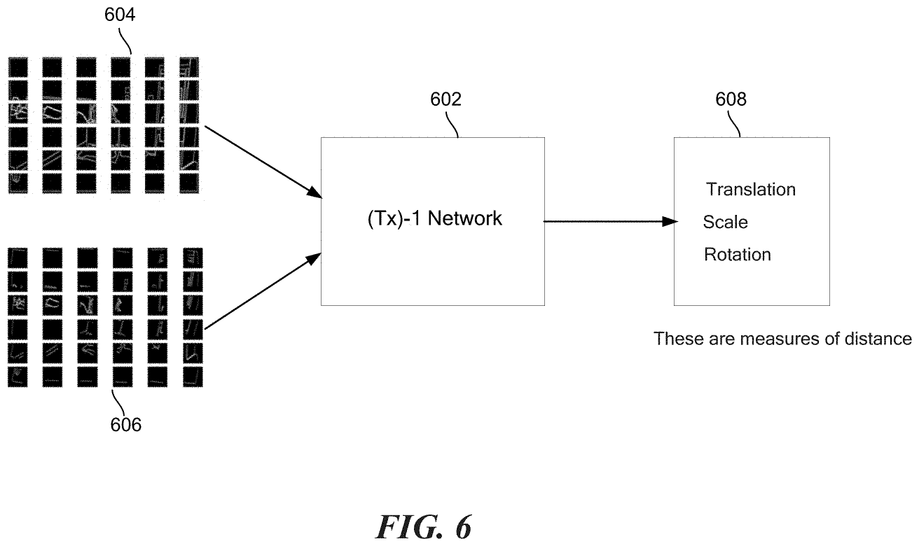

FIG. 6 is block diagram showing neural network training for distance-based features, in accordance with aspects of the present disclosure. FIG. 6 shows an inverse transforming ((Tx)-1) neural network 602. The (Tx)-1 neural network 602 receives a first set of images 604 and a second set of images 606. In some aspects of the present disclosure, each image is split into a set of images 604, 606 before being input to the (Tx)-1 neural network 602 to obtain a better representation of localized distance. The (Tx)-1 neural network 602 predicts distances 608 between the two sets of image 604, 606. In the example of FIG. 6, the (Tx)-1 neural network 602 predicts translation, scale and rotation distances 608 between the two sets of images 604, 606. In some aspects of the present disclosure, the distances 608 may correspond to an affine transformation matrix or a perspective transformation matrix. Once the (Tx)-1 neural network 602 is trained, the neural network weights are frozen and the norm of its output is used as a loss function to replace or augment cross-entropy loss.

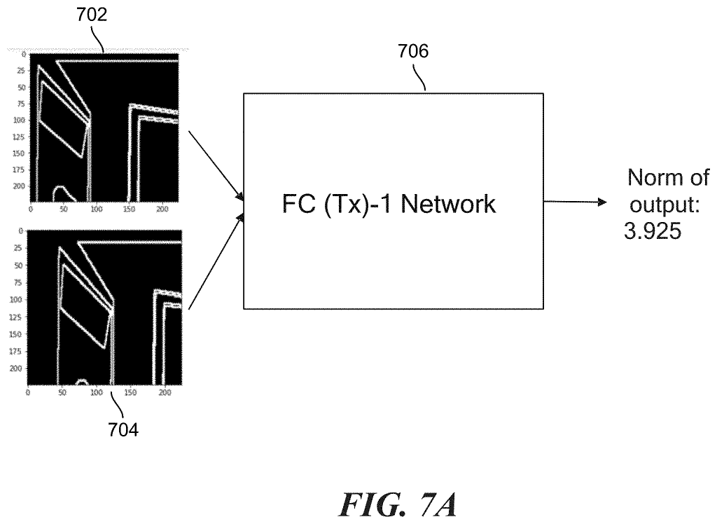

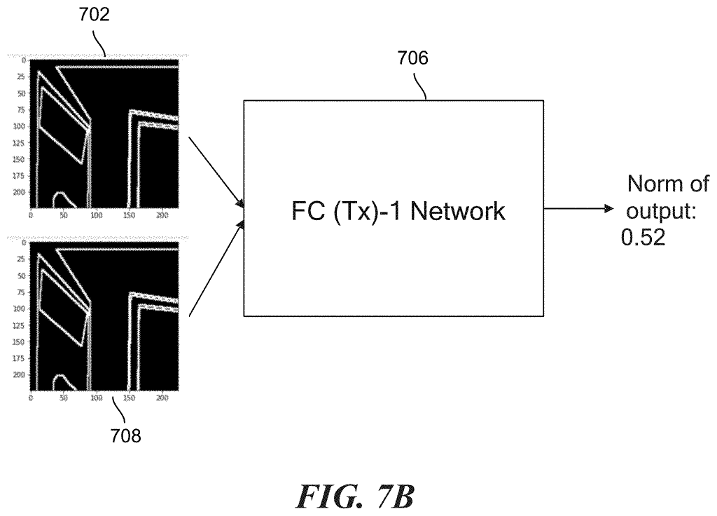

FIGS. 7A and 7B are diagrams showing distance-based measures of differences between pairs of input images, in accordance with aspects of the present disclosure. FIG. 7A shows a first image 702 and a second image 704. The first and second images 702, 704 may be output from a last layer for boundary detection, such as the last layer for boundary detection 404 of FIG. 4. A fully connected (FC) inverse transforming ((Tx)-1) neural network 706 may receive as input the pair of images 702, 704. The FC (Tx)-1 neural network 706 includes a distance-based loss function, such as the trained (Tx)-1 neural network 602 shown in FIG. 6. In the example of FIG. 7A, the second image 704 is a significantly shifted and scaled version of the first image 702. The differences between the images 702, 704 are represented as a norm of the output, which is the relatively high value of 3.925 for this example.

FIG. 7B shows the first image 702 and a third image 708, which may be output from a backbone network, such as the backbone 402 of FIG. 4. The fully connected (FC) inverse transforming (Tx)-1 neural network 706 receives the pair of images 702, 708. In the example of FIG. 7B, the third image 708 is a very slightly shifted and scaled version of the first image 702. The FC (Tx)-1 neural network 706 predicts differences between the images 702, 708, represented as a norm of the output, which is the relatively low value of 0.52 for this example. Thus, it can be seen that the distance-based loss function improves network performance. Although not shown in FIGS. 7A and 7B, a cross-entropy loss function can be applied in addition to the distance-based loss function to further improve performance.

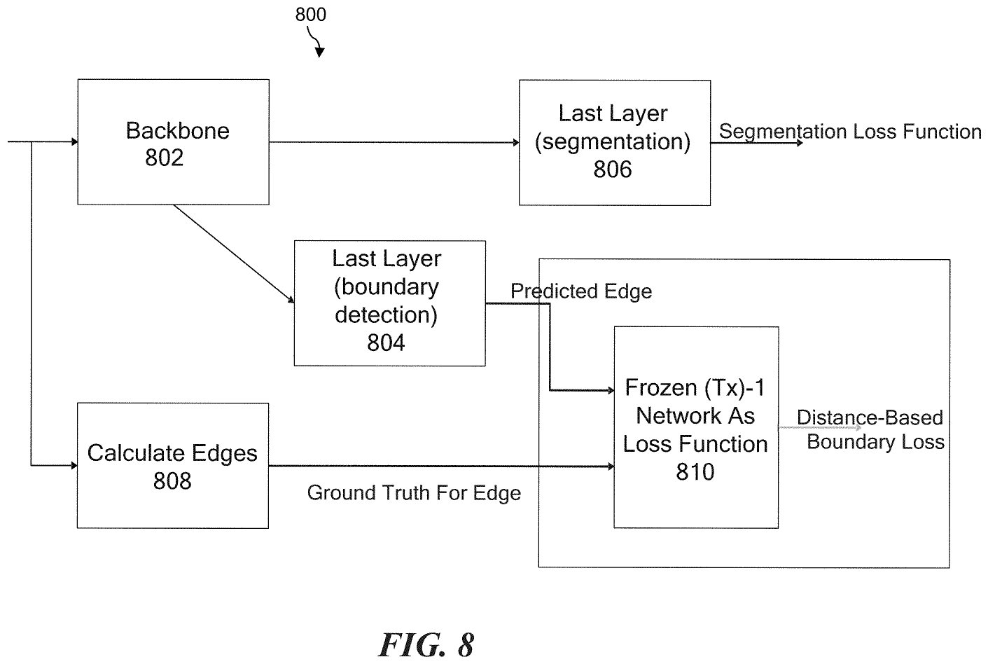

FIG. 8 is a block diagram showing a boundary detection and semantic segmentation model, in accordance with aspects of the present disclosure. The model 800 includes a backbone 802, a last layer for boundary detection 804, and a last layer for segmentation 806. To perform boundary detection and semantic segmentation, the backbone 802 of a neural network receives and processes an input image. The backbone 802 generates an output based on the processing. The last layer of the neural network for boundary detection 804 receives the output from the backbone 802. The last layer for boundary detection 804 predicts boundaries of the input image based on its processing of the output received from the backbone 802. The predicted boundaries are combined with the output from the backbone 802 and then input to the last layer for segmentation 806, which generates a segmentation loss for training of the model. The last layer for boundary detection 804 generates a predicted edge.

A module 808 that calculates edges provides ground truth labels to the (Tx)-1 neural network 810. The last layer for boundary detection 804 outputs a predicted edge to the (Tx)-1 neural network 810. Based on the input ground truth labels and the predicted edges, the (Tx)-1 neural network 810 is trained. Once trained, weights of the (Tx)-1 neural network 810 are frozen. The frozen (Tx)-1 neural network 810 can then be used to generate a distance-based boundary loss function, which may be used to train the backbone 802. Thus, performance of semantic segmentation improves, in addition to performance of the boundary detection, because boundary detection is improved. That is, segmentation and boundary detection use the shared backbone 802 that is trained on both semantic segmentation and boundary recognition.

To model spatial relations between two boundary maps, it is assumed that the boundary maps are related to each other through a homography transformation. A network inputs two boundary maps and predicts the homography change as its output. The network regresses on the transformation parameters between these maps as its output. The outputs of the inverse transformation network are the coefficients of a homography matrix. There are numerous methods to formulate a distance metric from these values. Two distance metric choices are now discussed: Euclidean distance and geodesic distance.

The Euclidean distance between two homography matrices is a measure of spatial distance between the two input boundary maps. The Euclidean distance may model shift and scale relations well. However, the Euclidean distance fails to reflect rotations and other perspective transformations. Considering the output of the network as \hat{θ}, the 3×3 identity matrix is I₃ and ∥ ∥_{F} is the Frobenius norm, the InverseForm distance is calculated as:

d_{if}(x,t_{θ}(x))=∥\hat{θ}−I₃∥_{F} (1)

where x and t_{θ}(x) are two images input to the inverse-transformation network architecture. The inverse transformation network is trained by reducing the Euclidean distance between predicted and ground truth parameters. Equation 1 may be used during inference.

For geodesic distance, homography transformations reside on an analytical manifold instead of a flat Euclidean space. The geodesic distance can capture these transformations. Considering the ground truth parameters as θ, the formulation of geodesic distance is as follows:

$${d}_{if} ( x , {t}_{θ} ( x ) ) = {‖ \frac{log ( {θ}^{- 1} \hat{θ} )}{log ( {I}_{3} )} ‖}_{F} \qquad ( 2 )$$

To train the network using this formulation of geodesic distance, gradient errors are calculated over the Riemannian logarithm, which does not have a closed form solution. Thus, the homography Lie group is projected onto a subgroup SO(3) where the calculation of geodesic distance does not need the Riemannian logarithm. The formulation is given by:

$${d}_{if} ( x , {t}_{θ} ( x ) ) = {cos}^{- 1} [ \frac{Tr ( P ) - 1}{2} ] + λ Tr ( {R}_{π}^{T} {R}_{π} ) \qquad ( 3 )$$

where λ is a hyperparameter set at a value such as 0.1, and the projection P onto the rotation group SO(3) is given as P=U diag{1, 1, det(UV)^{T}}V^{T}, where T represent the transpose operation, Tr represents the trace of the matrix, U and V are matrices from the singular value decomposition (SVD), diag and det are the diagonal and determinants and the projection residual R_{π} is calculated as:

R_{π}=θ⁻¹\hat{θ}−P (4)

This formulation of geodesic distance may be used to train the inverse transformation network. During inference, θ=I₃ is inserted into Equation 4 to compute the distance between two inputs to the inverse transformation network.

When using geodesic distance, there are eight degrees of freedom in the 3×3 homography matrix. The inverse transformation network predicts eight values and sets the ninth value to one. On the other hand, the matrix has six degrees of freedom if only two-dimensional (2D) affine transformations are assumed. Hence, the network predicts six values if the Euclidean distance measure is employed.

Once the inverse transformation network is trained, its weights are frozen and it is used as a loss function in a boundary-aware segmentation setting. Using networks as loss functions is a common practice for generative adversarial networks. The inverse transformation network, however, does not fall in the category of discriminator or adversarial losses. To model the loss function, it is assumed that the predicted boundary b_{pred} is a transformed version of the ground truth boundary label b_{gt}, e.g., b_{pred}=t_{θ}(b_{gt}). Hence, the InverseForm loss function can be formulated in terms of a spatial distance calculated as described below. This function first splits the input boundaries b_{pred} and b_{g}t into N smaller tiles b_{pred,j} and b_{gt,j}. Next, it passes the inputs through the inverse transformation network and calculates spatial distance in one of the ways described above. The formulation of the inverse loss function L_{if} is given by:

$${L}_{if} ( {b}_{pred} , {b}_{gt} ) = {\sum }_{j = 1}^{N} {d}_{if} ( {b}_{pred , j} , {b}_{gt , j} ) \qquad ( 5 )$$

Various architectures may be trained with the loss function, with both single-task and multi-task settings. For multi-task settings, the InverseForm loss term may be added to the boundary loss obtained from existing architectures. To train single-task architectures using InverseForm loss, a simple boundary-aware segmentation setup may be used. This setup may be used over any backbone. Consider x as the input image, y_{gt} as the ground truth segmentation map and y_{pred} is the network predicted segmentation map. The network produces intermediate features f_{pred}, which are fed into a segmentation backbone to produce the output segmentation. The features f_{pred} are passed into an auxiliary head to produce a boundary map b_{pred}. Optionally, this boundary map is concatenated with the features f_{pred} and then fed to the segmentation head to produce the output segmentation map y_{pred}.

Pixel-wise cross-entropy loss Lₓₑ is used on the segmentation output. The ground truth y_{gt} is passed through a Sobel filter to produce a binary boundary map. The InverseForm loss and pixel-wise cross-entropy may be integrated into the overall loss function. The overall loss function may be defined as:

Lₜₒₜₐₗ=Lₓₑ(y_{pred},y_{gt})+βLₓₑ(b_{pred},b_{gt})+γL_{if}(b_{pred},b_{gt} (6)

where Lₓₑ is the cross-entropy loss, L_{b}xe is the weighted cross-entropy loss, and L_{if} is the InverseForm loss defined in Equation 5. The parameters β and γ are scaling parameters for the weighted cross-entropy loss and InverseForm loss, respectively. They may be treated as hyperparameters.

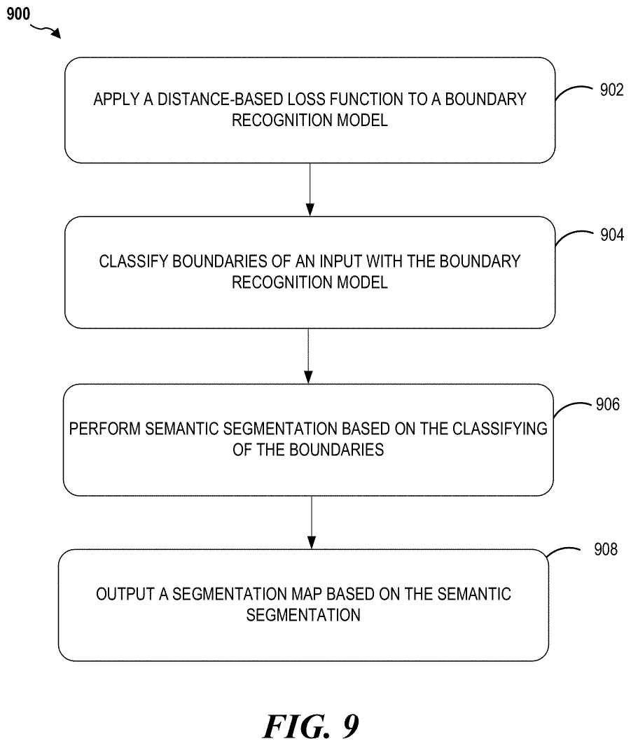

FIG. 9 is a flow diagram illustrating a method 900 for operating a neural network, in accordance with aspects of the present disclosure. As shown in FIG. 9, at block 902, the method 900 applies a distance-based loss function to a boundary recognition model. The distance may be a Euclidean distance or a geodesic distance. A geodesic distance may be based on a projection onto a rotation group.

At block 904, the method 900 classifies boundaries of an input with the boundary recognition model. The boundary detection recognition model may predict boundaries of the input image based on its processing of output received from a backbone network. The backbone network can be any type of backbone network.

At block 906, the method 900 performs semantic segmentation based on the classifying of the boundaries. Pixel-wise cross-entropy loss may be used on the segmentation output. The ground truth may be passed through a Sobel filter to produce a binary boundary map. An InverseForm loss and pixel-wise cross-entropy may be integrated into an overall loss function.

At block 908, the method 900 outputs a segmentation map showing different classes of objects from the input, based on the semantic segmentation. In some aspects, a boundary map is concatenated with features and then fed to a segmentation head to produce the output segmentation map.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

### EXAMPLE ASPECTS

Aspect 1: A computer implemented method, comprising: applying a distance-based loss function to a boundary recognition model; classifying boundaries of an input with the boundary recognition model; performing semantic segmentation based on the classifying of the boundaries; and outputting a segmentation map showing different classes of objects from the input, based on the semantic segmentation.

Aspect 2: The method of Aspect 1, further comprising training an inverse transforming artificial neural network to predict a perspective transformation of an image, the trained artificial neural network comprising the distance-based loss function.

Aspect 3: The method of Aspect 1 or 2, further comprising freezing weights of the inverse transforming artificial neural network, after training, to obtain the distance-based loss function.

Aspect 4: The method of any of the preceding aspects, in which training the inverse transforming artificial neural network comprises generating shifted, translated, and scaled versions of the image, a ground truth comprising values corresponding to amounts of shifting, translating, and scaling.

Aspect 5: The method of any of the preceding aspects, in which the distance-based loss function is associated with a Euclidean distance.

Aspect 6: The method of any of preceding aspects 1-4, in which the distance-based loss function is associated with a geodesic distance.

Aspect 7: The method of any of preceding aspects 1-4 and 6, further comprising calculating the geodesic distance based on a projection onto a rotation group.

Aspect 8: An apparatus comprising: a processor; memory coupled with the processor; and instructions stored in the memory and operable, when executed by the processor, to cause the apparatus: to apply a distance-based loss function to a boundary recognition model; to classify boundaries of an input with the boundary recognition model; to perform semantic segmentation based on the classifying of the boundaries; and to output a segmentation map showing different classes of objects from the input, based on the semantic segmentation.

Aspect 9: The apparatus of Aspect 8, in which the processor causes the apparatus to train an inverse transforming artificial neural network to predict a perspective transformation of an image, the trained artificial neural network comprising the distance-based loss function.

Aspect 10: The apparatus of Aspect 8 or 9, in which the processor causes the apparatus to freeze weights of the inverse transforming artificial neural network, after training, to obtain the distance-based loss function.

Aspect 11: The apparatus of any of the aspects 8-10, in which the processor causes the apparatus to train the inverse transforming artificial neural network that generates shifted, translated, and scaled versions of the image, a ground truth comprising values corresponding to amounts of shifting, translating, and scaling.

Aspect 12: The apparatus of any of the aspects 8-11, in which the distance-based loss function is associated with a Euclidean distance.

Aspect 13: The apparatus of any of the aspects 8-11, in which the distance-based loss function is associated with a geodesic distance.

Aspect 14: The apparatus of any of the aspects 8-11 and 13, in which the processor is further configured to calculate the geodesic distance based on a projection onto a rotation group.

Aspect 15: A device, comprising: means for applying a distance-based loss function to a boundary recognition model; means for classifying boundaries of an input with the boundary recognition model; means for performing semantic segmentation based on the classifying; and means for outputting a segmentation map showing different classes of objects from the input, based on the semantic segmentation.

Aspect 16: The device of Aspect 15, further comprising means for training an inverse transforming artificial neural network to predict an affine transformation of an image, the trained artificial neural network comprising the distance-based loss function.

Aspect 17: The device of Aspect 15 or 16, further comprising means for freezing weights of the inverse transforming artificial neural network, after training, to obtain the distance-based loss function.

Aspect 18: The device of any of the aspects 15-17, in which the means for training the inverse transforming artificial neural network comprises means for generating shifted, translated, and scaled versions of the image, a ground truth comprising values corresponding to amounts of shifting, translating, and scaling.

Aspect 19: The device of any of the aspects 15-18, in which the distance-based loss function is associated with a Euclidean distance.

Aspect 20: The device of any of the aspects 15-18, in which the distance-based loss function is associated with a geodesic distance.

Aspect 21: The device of any of the aspects 15-18 and 20, further comprising means for calculating the geodesic distance based on a projection onto a rotation group.

Aspect 22: A non-transitory computer-readable medium having program code recorded thereon, the program code executed by a processor to implement any of aspects 1-7.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A computer implemented method, comprising:
applying a distance-based loss function to a boundary recognition model;
classifying boundaries of an input with the boundary recognition model;
performing semantic segmentation based on the classifying of the boundaries; and
outputting a segmentation map showing different classes of objects from the input, based on the semantic segmentation.

2. The method of claim 1, further comprising training an inverse transforming artificial neural network to predict a perspective transformation of an image, the trained artificial neural network comprising the distance-based loss function.

3. The method of claim 2, further comprising freezing weights of the inverse transforming artificial neural network, after training, to obtain the distance-based loss function.

4. The method of claim 2, in which training the inverse transforming artificial neural network comprises generating shifted, translated, and scaled versions of the image, a ground truth comprising values corresponding to amounts of shifting, translating, and scaling.

5. The method of claim 1, in which the distance-based loss function is associated with a Euclidean distance.

6. The method of claim 1, in which the distance-based loss function is associated with a geodesic distance.

7. The method of claim 6, further comprising calculating the geodesic distance based on a projection onto a rotation group.

8. An apparatus, comprising:
a processor;
memory coupled with the processor; and
instructions stored in the memory and operable, when executed by the processor, to cause the apparatus:
to apply a distance-based loss function to a boundary recognition model;
to classify boundaries of an input with the boundary recognition model;
to perform semantic segmentation based on the classifying of the boundaries; and
to output a segmentation map showing different classes of objects from the input, based on the semantic segmentation.

9. The apparatus of claim 8, in which the processor causes the apparatus to train an inverse transforming artificial neural network to predict a perspective transformation of an image, the trained artificial neural network comprising the distance-based loss function.

10. The apparatus of claim 9, in which the processor causes the apparatus to freeze weights of the inverse transforming artificial neural network, after training, to obtain the distance-based loss function.

11. The apparatus of claim 9, in which the processor causes the apparatus to train the inverse transforming artificial neural network that generates shifted, translated, and scaled versions of the image, a ground truth comprising values corresponding to amounts of shifting, translating, and scaling.

12. The apparatus of claim 8, in which the distance-based loss function is associated with a Euclidean distance.

13. The apparatus of claim 8, in which the distance-based loss function is associated with a geodesic distance.

14. The apparatus of claim 13, in which the processor is further configured to calculate the geodesic distance based on a projection onto a rotation group.

15. A device, comprising:
means for applying a distance-based loss function to a boundary recognition model;
means for classifying boundaries of an input with the boundary recognition model;
means for performing semantic segmentation based on the classifying; and
means for outputting a segmentation map showing different classes of objects from the input, based on the semantic segmentation.

16. The device of claim 15, further comprising means for training an inverse transforming artificial neural network to predict an affine transformation of an image, the trained artificial neural network comprising the distance-based loss function.

17. The device of claim 16, further comprising means for freezing weights of the inverse transforming artificial neural network, after training, to obtain the distance-based loss function.

18. The device of claim 16, in which the means for training the inverse transforming artificial neural network comprises means for generating shifted, translated, and scaled versions of the image, a ground truth comprising values corresponding to amounts of shifting, translating, and scaling.

19. The device of claim 15, in which the distance-based loss function is associated with a Euclidean distance.

20. The device of claim 15, in which the distance-based loss function is associated with a geodesic distance.

21. The device of claim 20, further comprising means for calculating the geodesic distance based on a projection onto a rotation group.

22. A non-transitory computer-readable medium having program code recorded thereon, the program code executed by a device and comprising:
program code to apply a distance-based loss function to a boundary recognition model;
program code to classify boundaries of an input with the boundary recognition model;
program code to perform semantic segmentation based on the classifying of the boundaries; and
program code to output a segmentation map showing different classes of objects from the input, based on the semantic segmentation.
